(19) United States
(12) Patent Application Publication
(10) Pub. No.: US 2015/0294406 A1
(43) Pub. Date: Oct. 15, 2015

(54) SYSTEM AND METHOD FOR INTEGRATED DUE DILIGENCE AND CREDIT RISK MANAGEMENT ANALYTICS AND QUALITY CONTROL

(71) Applicant: Mela Capital Group, Inc, Sunrise, FL (US)

(72) Inventors: Cindi Dixon, Vero Beach, FL (US); Karl Dixon, Vero Beach, FL (US)

(73) Assignee: Mela Capital Group, Inc.

(21) Appl. No.: 14/685,838

(22) Filed: Apr. 14, 2015

Related U.S. Application Data
(60) Provisional application No. 61/979,860, filed on Apr. 15, 2014.

(51) Int. Cl. G06Q 40/02

(52) U.S. Cl. CPC G06Q 40/025

(57) ABSTRACT

A system and method for due diligence reporting comprises: gathering data relevant to a loan from data sources; populating a risk related template, by a computer, according to the gathered data; gathering verified data; comparing the gathered data with the verified data; identifying variances between the gathered data and the verified data; and generating a risk analysis report according to the identified variances.

### CROSS REFERENCE TO RELATED PATENT APPLICATIONS

This patent application claims the priority and benefit of U.S. provisional patent application 61/979,860, entitled “System and Method for Integrated Due Diligence and Credit Risk Management Analytics and Quality Control”, filed on Apr. 15, 2014. This patent application therefore claims priority to U.S. Provisional Patent Application Ser. No. 61/979,860, which is incorporated herein by reference in its entirety.

### FIELD OF THE INVENTION

This invention is generally related to methods and systems for fully integrated due diligence and credit risk management analytics and quality control via a software platform for use in processing credit underwriting applications.

### BACKGROUND

Due diligence and credit risk management are critically important aspects in portfolio loan risk assessment. However, sources of information related to this task are vast and gathering this information and concatenating it into a usable form is nearly impossible because of the extent of information that must be processed. Accordingly, a need exists for integrated due diligence and credit risk management analytics and quality control for use in processing credit underwriting applications.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method and system for credit risk analytics.

It is another aspect of the disclosed embodiments to provide a method and system for due diligence integration in credit risk analytics.

It is yet another aspect of the disclosed embodiments to provide an enhanced method and system for collecting and processing third party underwriting and quality control verifications to evaluate individual and portfolio loan risk analytics

The aforementioned aspects and other objectives and advantages can now be achieved as described herein. A system and method for due diligence reporting comprises: gathering data relevant to a loan from data sources; populating a risk related template, by a computer, according to the gathered data; gathering verified data; comparing the gathered data with the verified data; identifying variances between the gathered data and the verified data; and generating a risk analysis report according to the identified variances.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system in accordance with the disclosed embodiments;

FIG. 2 depicts a block diagram of a computer network in accordance with the disclosed embodiments;

FIG. 3 depicts a block diagram of a computer software system in accordance with the disclosed embodiments;

FIG. 4 depicts a block diagram of a system for integrated due diligence and credit risk management analytics and quality control in accordance with another embodiment of the invention;

FIG. 5 depicts logical operational steps associated with a method for integrated due diligence and credit risk management analytics and quality control in accordance with another embodiment of the invention;

FIG. 6 depicts an alternative embodiment of logical operational steps associated with a method for integrated due diligence and credit risk management analytics and quality control in accordance with another embodiment of the invention; and

FIG. 7 depicts a block diagram of a system associated with methods and systems for integrated due diligence and credit risk management analytics and quality control in accordance with another embodiment of the invention.

### DETAILED DESCRIPTION

The particular values and configurations discussed in these non-limiting examples can be varied and are cited merely to illustrate at least one embodiment and are not intended to limit the scope thereof.

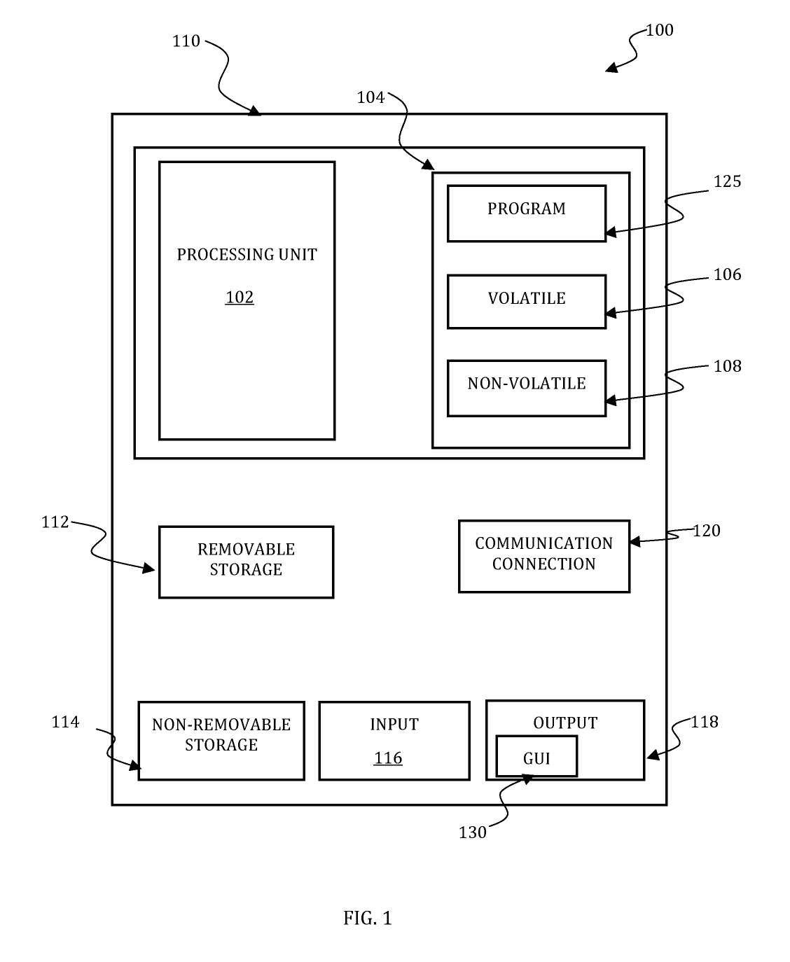

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing the methods and systems disclosed herein is shown in FIG. 1. A general computing device in the form of a computer 110 may include a processing unit 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM). Digital Versatile Disks (DVD) or other optical disk storage, magnetic cassettes, magnetic tape, magnetic disk storage, or other magnetic storage devices, or any other medium capable of storing computer-readable instructions as well as data.

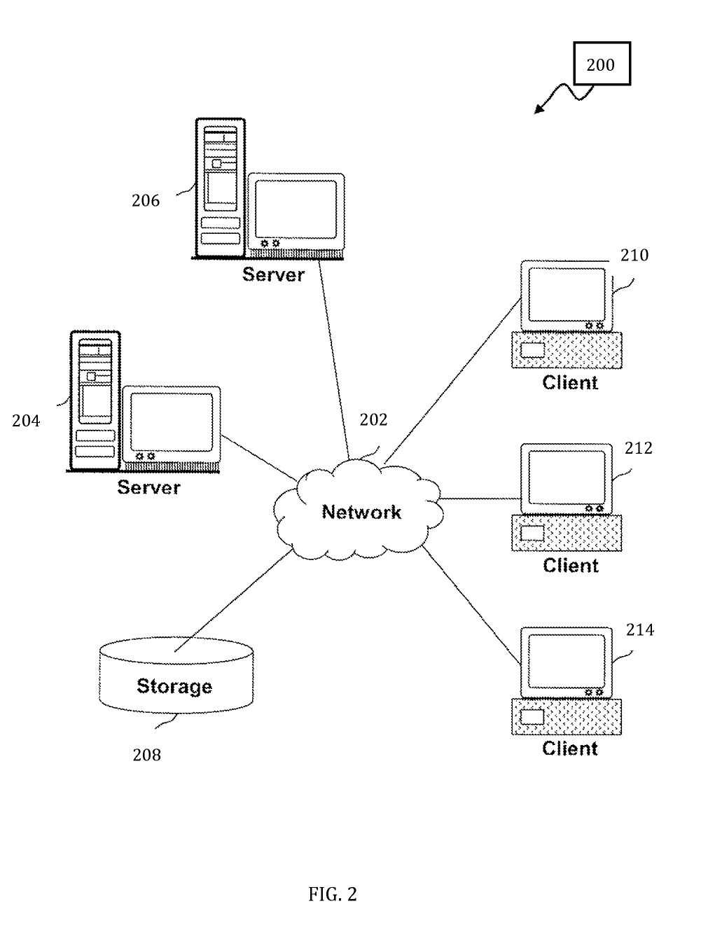

Computer 110 may include or have access to a computing environment that includes input 116, output 118, and a communication connection 120. The computer may operate in a networked environment using a communication connection to connect to one or more remote computers or devices. The remote computer may include a personal computer (PC), server, router, network PC, a peer device or other common network node, or the like. The communication connection may include a Local Area Network (LAN), a Wide Area Network (WAN), or other networks. This functionality is described more fully in the description associated with FIG. 2 below.

Output 118 is most commonly provided as a computer monitor. but may include any computer output device. Output 118 may also include a data collection apparatus associated with computer system 100. In addition, input 116, which commonly includes a computer keyboard and/or pointing device such as a computer mouse, computer track pad, or the like, allows a user to select and instruct computer system 100. A. user interface can be provided using output 118 and input 116. Output 118 may function as a display for displaying data and information for a user and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse, and/or with a keyboard. A particular item can function in the same manner to the user in all applications because the GUI provides standard software routines (e.g., module 125) to handle these elements and report the user's actions.

Computer-readable instructions, for example, program module 125, which can be representative of other modules described herein, are stored on a computer-readable medium and are executable by the processing unit 102 of computer 110. Program module 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers in which embodiments of the present invention may be implemented. Note that the system 200 can be implemented in the context of a software module such as program module 125. The system 200 includes a network 202 in communication with one or more clients 210, 212, and 214. Network 202 is a medium that can be used to provide communication links between various devices and computers connected together within a networked data processing system such as computer system 100. Network 202 may include connections such as wired communication links, wireless communication links such as cloud based connection, or fiber optic cables. Network 202 can further communicate with one or more servers 204 and 206, and a memory storage unit such as, for example, memory or database 208.

In the depicted example, servers 204 and 206 connect to network 202 along with storage unit 208. In addition, clients 210, 212, and 214 connect to network 202. These clients 210, 212, and 214 may be, for example, personal computers or network computers. Computer system 100 depicted in FIG. 1 can be, for example, a client such as client 210, 212. and/or 214.

Computer system 100 can also be implemented as a server such as server 206, depending upon design considerations. In the depicted example, server 206 provides data such as boot files, operating system images, applications, and application updates to clients 210, 212, and 214. Clients 210, 212, and 214 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

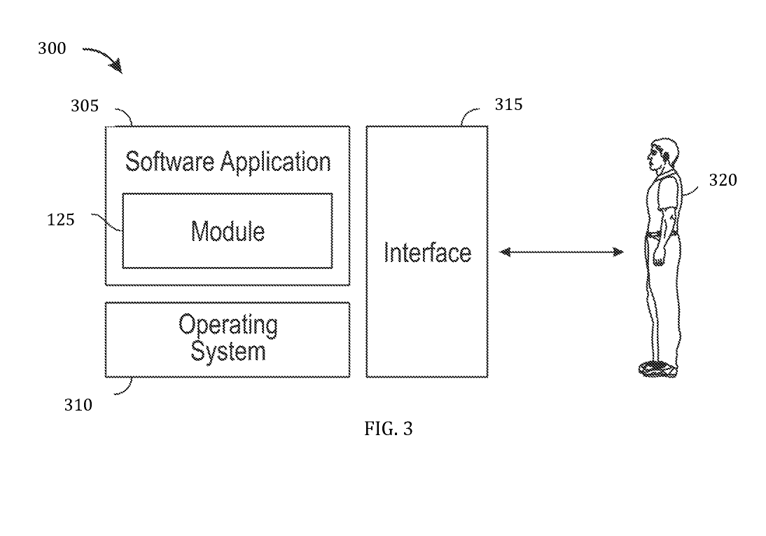

FIG. 3 illustrates a computer software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) 125, may be “loaded” (i.e., transferred from non-removable storage 114 into the memory 104) for execution by the data-processing system 100. The data-processing system 100 can receive user commands and data through user interface 315, which can include input 116 and output 118, and accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked personal computers, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, load origination, loan risk analysis, etc.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the system and method of the present invention may be advantageously applied to a variety of system and application software including database management systems, word processors, and the like. Moreover, the present invention may be embodied on a variety of different platforms including Macintosh, UNIX, LINUX, and the like. Therefore, the descriptions of the exemplary embodiments, which follow, are for purposes of illustration and not considered a limitation.

The particular values and configurations discussed in these non-limiting examples can be varied and are cited merely to illustrate at least one embodiment and are not intended to limit the scope thereof. Various modifications to the preferred embodiments, disclosed herein, will be readily apparent to those.

The invention comprises, in one embodiment, a fully integrated due diligence and credit risk management analytic quality control and underwriting system for use in processing credit underwriting applications including: residential mortgage lending, commercial mortgage lending, residential mortgage backed securities (RMBS), portfolio due diligence, residential mortgage services, auto lending underwriting, student loan lending, residential leasing, homeowners insurance underwriting, auto insurance underwriting, etc.

The system uses a design and a risk model that integrates all the required third party underwriting and quality control verifications including, but not limited to, Trimerge Credit Report, Subject Property Valuation, Subject Property Transaction History, Subject Property Neighborhood Economics, Subject Property Collateral Assessment, Comparable Property Valuation, Comparable Property Transaction History, Comparable Property Neighborhood Economics, Comparable Property Collateral Assessment, Property Lien Verification, MMLS License Verification, Office of Foreign Asset Control, OFACE, Terrorist Watch List, FEMA Flood Zone Certification, Residential Home Loan Federal Compliance Testing, Residential Home Loan State Compliance Testing, Residential Home Loan Regional Compliance Testing, Residential Home Loan Fraud Detection Testing, Verification of Employment, Verification of Income, 4506-T Processing, Mortgage History Verification, Rental Housing History Verification, Federal Tax Lien Verification, State Tax Lien Verification, Regional Tax Lien Verification, Student Loan Payment History, and United States Military Veteran Status to evaluate individual and portfolio analytics associated with loan risk. The third party verifications can be integrated using custom C#.Net code, or other such known code, and configuration files from third-party service providers.

The system can include a credit risk scoring model (or module) that imports individual loan level data and/or bulk portfolio loan level data from loan origination systems, custom lending platforms, and other client-directed sources including manual input. Upon completion of this data import, the gathered data is used for loan quality risk analysis. Loan quality risk analysis is achieved either using risk algorithms created for the system, or is batched and completed manually, according to the client or investor requirements.

A custom individual loan summary report (ILS), portfolio summary report (PSR), and delta deficiency reports (DDR) are generated according to the client's internal and/or investor reporting requirements. The ILS, PSR, DDR, and other reports are data-driven risk reports that apply to individual loan quality, portfolio quality, and underwriter/loan processor quality. These can be embodied as templates filled in with the gathered individual loan level data.

This data is then validated against a third party or source data provider (e.g., credit score comes from Equifax). Variances between the gathered data validated source data, where identified, are captured in one or more data tables. The delta variance is the difference between the source data and the validated data. The delta variance can be weighted according to any one of many known credit risk models. In a preferred embodiment, the model is developed using a weighted average for all data points. An internal risk scale is used to rate the potential material loan performance impact of the data.

In another embodiment, manual underwriting and quality control reviews can be conducted after the data integrity validation is processed using the system. Underwriters or auditors can select individual or bulk verification processing. Due diligence findings can be imported into the system, parsed, and then can be managed in a secured environment, which is kept separate from material accessible by a loan reviewer. A loan quality rating comprising an internal quality control risk model is used to score each loan in accordance with validation of underwriting and/or quality control review findings. Variances can be measured and reported on a weighted scale, which can be from 0-100, or other such scale, for each unit reviewed. The score is determined by the system using any acceptable scoring algorithm.

The system can provide red and green highlights or flag displays for each key risk section associated with the system requiring data input or analysis. Upon either manual or automated completion of accurate data input for each identified field, the red highlights or flags, which indicate incomplete or incorrect information, are converted to green highlights or flags, indicating a valid enumeration has been captured for the field. Each section of the system can further include internal quality control checks where manual calculations, data input, and discrepancy testing is checked for the given section of the system. This reduces human error and allows cross-referencing of key data elements to ensure more consistent data and reduces discrepancies caused by incomplete or inaccurate data input.

A production cycle for quality control loan review consists of underwriter review of origination or source data. Automated controls can be provided that allow for the isolation of loans upon completion of underwriting or quality control review. This can advance the loan unit through its production cycle, locking the loan from reviewer access at each layer after completion.

The system automates loan unit assignments to each underwriter in predetermined, automated cycles. A typical reviewer may receive three to eight loan units per day. The system can be supported by a back office administrative monitoring system that allows management users with designated authority to see, in real time, which underwriters are actively using the system, idle versus active time for each user, what the current review status for each loan is, timed periods of inactivity, and duration since last login.

After a reviewer has completed a loan review, they change the status of the loan to “complete”. Once a loan status is changed to “complete”, the associated data is incorporated into the risk calculation database and all the associated scores are updated and reported.

The system randomly samples a designated percentage of the reviewer's product for examination via internal quality control review. The quality control process allows for the manual review of underwriters loan file reviews. The risk model is applied to the reviewer level for each loan and provides an underwriter score card for each loan and an aggregated total for each underwriter. Management controls are also included which provide live time production activity monitoring, underwriter score card risk model, and live time quality control reporting and red flags. Management controls can provide remote and on-site production management tools in order to analytically manage project production flow and quality control sampling. Delta deficiency algorithms can be used to facilitate large data management in the enterprise, risk, and production management environments.

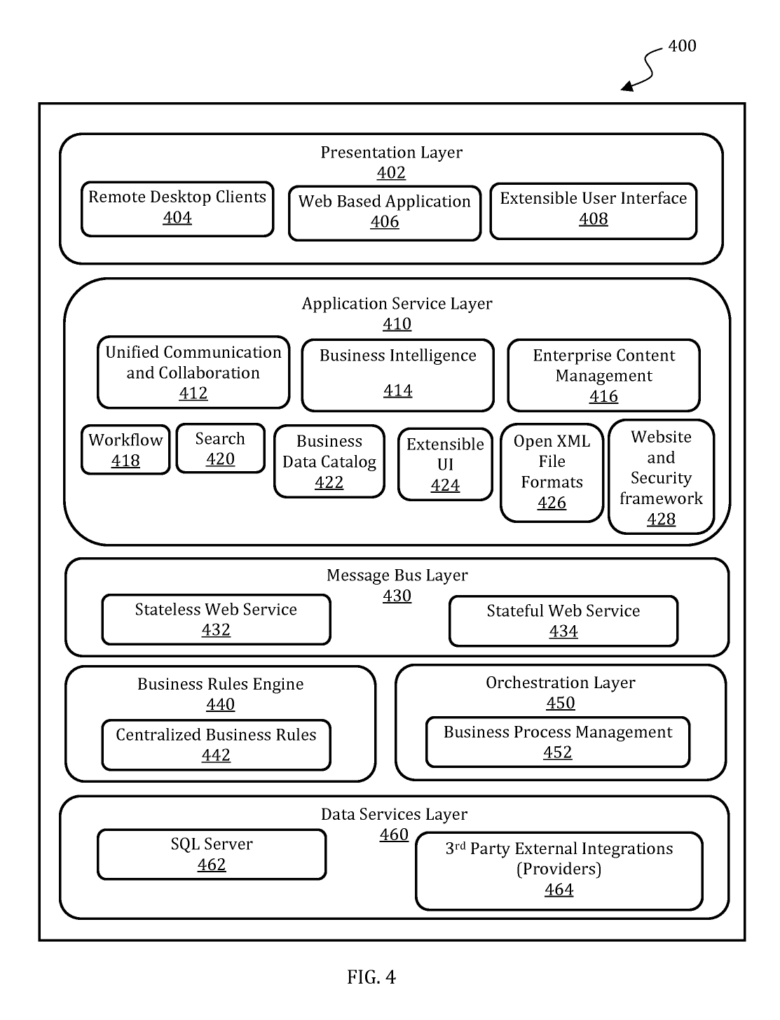

In the embodiment illustrated in FIG. 4, a tiered (or layered) software system 400 is shown. The business tier of the invention is comprised of high-level processes for loan origination and quality control. FIG. 4 illustrates the technical architecture in each logical layer along with modules contained within each layer.

Presentation layer 402 serves as the interface accessed by system users. There can be various services that can be accessed in this environment. These services include remote desktop module 404 and web-based applications module 406. The user interface module 408 can be driven by the user context.

Application service layer 410 is a reusable layer that allows applications to use functionality such as unified communications and collaboration module 412, enterprise content management module 416, and business intelligence module 414 which is acquired from other services. Included in application service layer 410 are workflow module 418, search module 420, business data catalog module 422, extensible UI module 424, open XML file formats module 426, and website and security framework module 428.

The message bus layer 430 creates the infrastructure for communication and messaging. This layer may include a stateless web service module 432 and a stateful web service module 434. Message bus layer 430 may implement or use other products such as Microsoft BizTalk, which operates as a message bus.

Business rule layer 440 provides centralized business rules via centralized business rules module 442 to build consistency, reliability, and cost reduction into the system architecture. These rules are created to distribute or pull origination and quality control data from internal and external systems. Orchestration layer 450 is responsible for all process development of origination and quality control data and management of data. This may be accomplished via business process management module 452.

In data services layer 460, relational database services and management occur. This may be accomplished via SQL server module 462 and 3^{rd} party external integrations module 464.

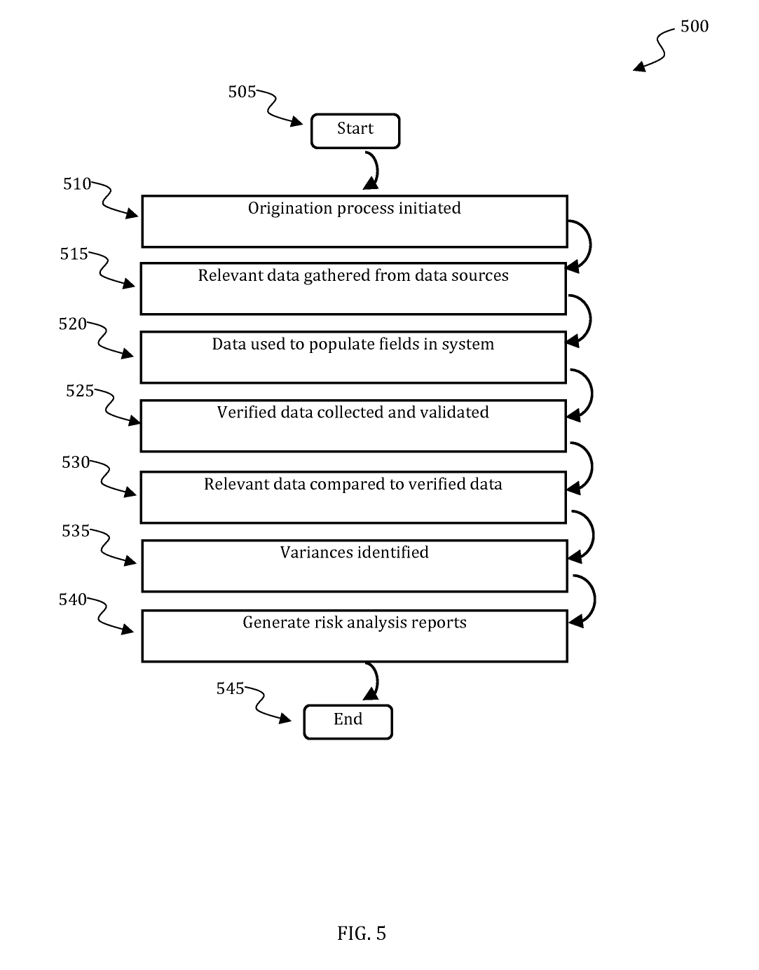

FIG. 5 illustrates a flow chart 500 of logical operational steps associated with the methods and systems disclosed herein. The method begins at step 505. In one embodiment when the module 125 is initiated in an origination process at step 510, data is identified from a Loan Origination System (LOS), and/or from data stored on hard disks, USB drives, CDs, and other electronic media, and/or manually collected as shown by step 515. Data is imported as both structured and unstructured formats, and any unstructured documents are subject to an optical character recognition (OCR) utility in order to make the unstructured documents searchable. The collected data may be used to populate various fields associated with the system at step 520.

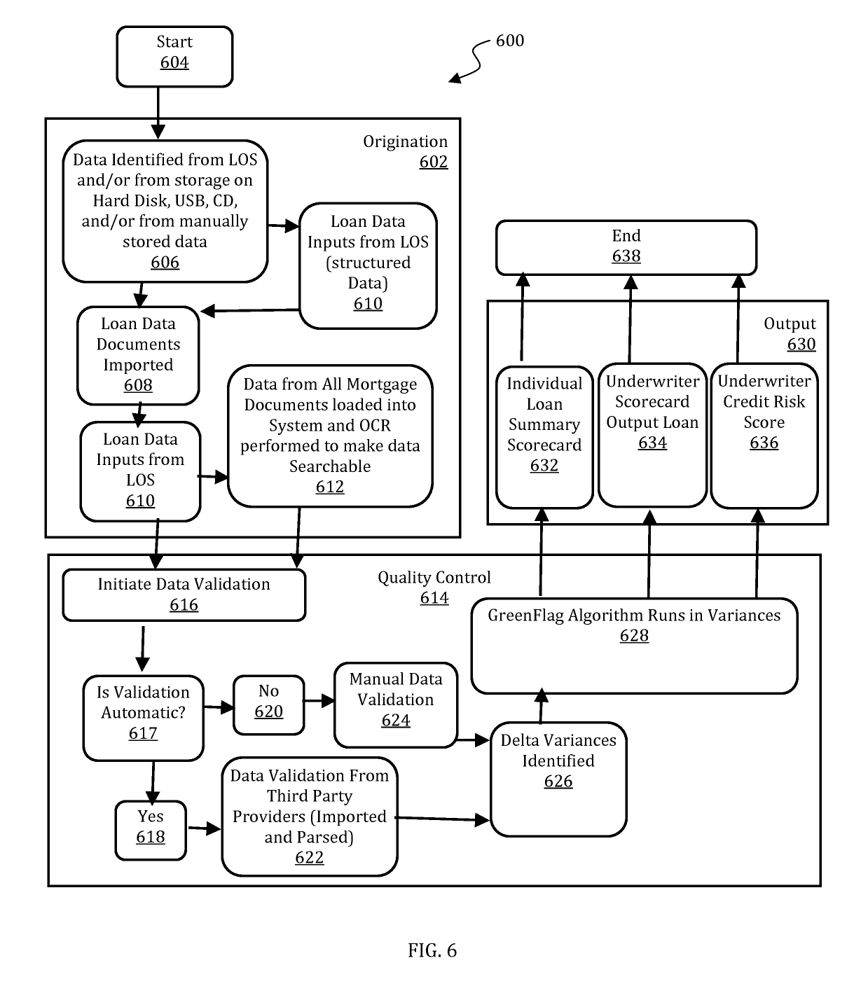

Next, the invention provides a quality control process, where data validation occurs. When the system has all of the data from loans, which is imported, or the system can create a new layer of the loan, the goal is to input the correct data. This verified data can be collected at step 525. When a third party service is used to validate the data, it will automatically input the correct data. A manual process may be run to enter any manual data inputs and see if the data exists or not. The invention may also use third party providers to import and parse validated data. That data describes loan origination data imported automatically. In some cases, loan data inputs will not have automatic data validation and are considered manual processes. Steps associated with the methods disclosed herein are further illustrated in FIG. 6.

After data is validated, the delta variances are determined at step 530. The delta variances are the difference between the origination data and the third-party verified data. The system identifies these variances at step 535, and then outputs are created, embodied as an individual loan summary scorecard, underwriter scorecard output loan, and/or underwriter credit risk score as shown at step 540. The method ends at step 545.

According to the method 500 disclosed in FIG. 5, the system utilizes a delta variance calculation to identify variances between the origination loan data and the validated quality control reviewed loan data. The delta variances are scored using algorithms designed to output an internal risk score, weighted by the loan performance/scalability impact.

For example, a misspelled last name will be weighted as a “1” on a scale of 1-5. The error will not impact future loan performance, or whether an investor will want to acquire the loan. An incorrect Social Security number will be weighted as a “5” because the credit profile, debt to income ratios, and who the borrower is is incorrect.

FIG. 6 illustrates another illustration of a method 600 wherein due diligence and credit risk management analytics and quality control are provided via the systems disclosed herein. The method begins at step 604. During the origination stage 602, at step 606 data identified from the LOS and/or from storage on hard disk, USB, CD, and/or from manually stored data is acquired. From here structured data at step 610 may be collected. Next, the loan data documents are imported at step 608 and load data from the LOS are input at step 610. The data is next loaded into the system and OCR may optionally be performed to make the data searchable, as shown at step 612.

The method next moves to the quality control stage 614. Here, data validation is initiated at step 616. The system determines if validation is automatic at step 617. If the answer is “yes” at step 618, then data validation from third party providers is imported and parsed at step 622. If the answer is “no” at step 620, then manual validation is required at step 624. The method then moves forward in either case, where delta variances are identified at step 626. The system can then use algorithms to run in the variances, as shown at step 628.

From here, the output stage 630 is completed. In this stage, an individual loan summary scorecard 632, underwriter scorecard 634, and/or underwriter credit risk scorecard 636 can be created. The method then ends at step 638.

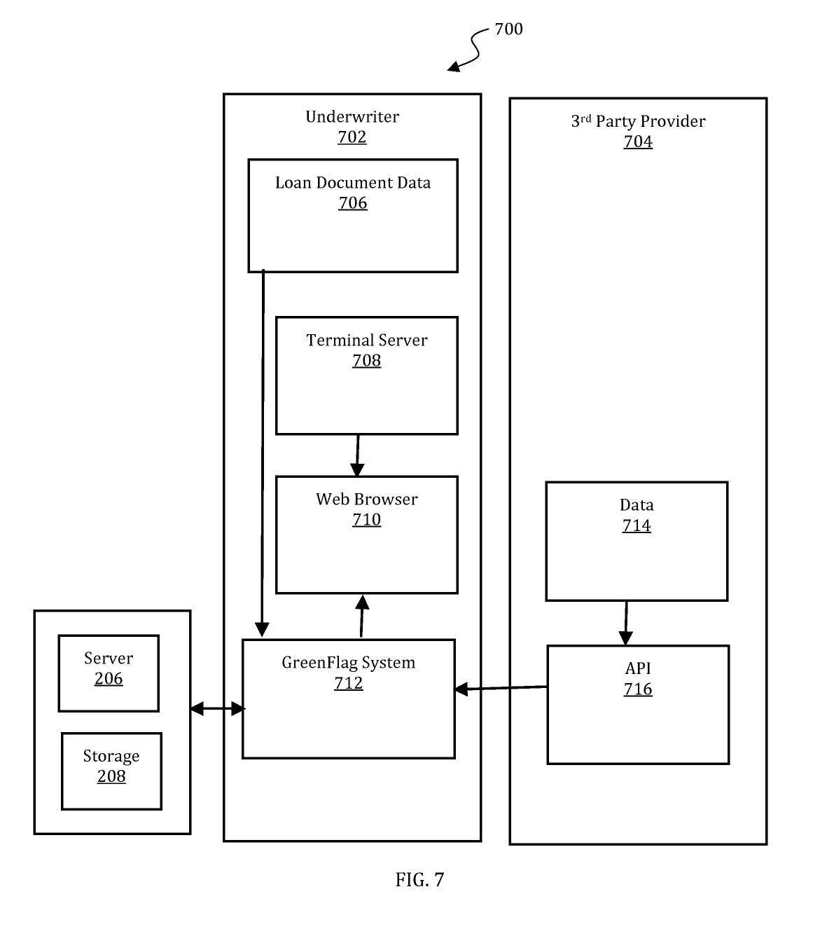

FIG. 7 provides another block diagram of a system 700 for due diligence and credit risk management analytics and quality control. The system may include server 206 and storage 208. The underwriter 702 may provide loan document data 706 and a terminal server 708. The terminal server 708 is operably connected with a web browser 710 which may serve as a user interface. The web browser 710 receives data from the system 712. The system 712 is configured to perform processes as illustrated in FIGS. 5 and 6, and may receive loan document data 706 as shown. A third party provider 704 may also have data 714 and may provide such data to the system 712 via an API 716.

In sum, the invention provides a method and system for automated due diligence reporting and credit risk management analytics quality control by accepting loan and risk related data, parsing that data into a usable form, and using that data to create a risk analysis report for clients.

Based on the foregoing, it can be appreciated that a number of embodiments, preferred and alternative, are disclosed herein. For example, in one embodiment, a computer-implemented method for due diligence reporting, the method comprises gathering data relevant to a loan from data sources; populating a risk related template, by a computer, according to the gathered data; gathering verified data; comparing, by said computer, the gathered data with the verified data; identifying variances between the gathered data and the verified data; and generating a risk analysis report, by said computer, according to the identified variances.

The risk analysis report comprises a score for at least one of an individual loan summary scorecard; an underwriter scorecard; and an underwriter credit risk score. The verifying of the verified data further comprises validating the gathered data; and determining delta variances between the gathered data and the verified data. In another embodiment, the verified data comprises data provided by a third party.

In another embodiment, generating the risk analysis report further comprises assigning said score a loan performance scalability impact weight. The method further comprises manually reviewing said gathered data relevant to said loan and said gathered verified data. The method also comprises highlighting key risk sections of said risk related template.

In another embodiment, the highlighting indicates at least one of missing input, data missing analysis data incorrect information; valid data type in said field; and invalid data type in said field.

In another embodiment, a system for due diligence reporting comprises a processor and a computer-usable medium embodying computer code, said computer-usable medium being coupled to said processor, said computer code comprising non-transitory instruction media executable by said processor for: gathering data relevant to a loan from data sources; populating a risk related template according to the gathered data; gathering verified data; comparing the gathered data with the verified data identifying variances between the gathered data and the verified data; and generating a risk analysis report according to the identified variances. The risk analysis report comprises a score for at least one of an individual loan summary scorecard; an underwriter scorecard; and an underwriter credit risk score.

In one embodiment, the gathered data with the verified data further comprises validating said gathered data and determining delta variances between said gathered data and said verified data. The verified data comprises data provided by a third party.

In another embodiment, generating said risk analysis report further comprises assigning said score a loan performance scalability impact weight. The system further comprises manually reviewing said gathered data relevant to said loan and said gathered verified data. In another embodiment, the system further comprises highlighting key risk sections of said risk related template.

In yet another embodiment, the highlighting indicates at least one of missing input data; missing analysis data; incorrect information; valid data type in said field; and invalid data type in said field.

In another embodiment, a computer-implemented method for due diligence reporting comprises: gathering data relevant to a loan from data sources; populating a risk related template, by a computer, according to the gathered data; gathering verified data; validating said gathered data; determining delta variances between said gathered data and said verified data; comparing, by said computer, the gathered data with the verified data: identifying variances between the gathered data and the verified data; manually reviewing said gathered data relevant to said loan and said gathered verified data; and generating a risk analysis report, by said computer, according to the identified variances.

The risk analysis report comprises a score for at least one of an individual loan summary scorecard; an underwriter scorecard; and an underwriter credit risk score. Generating said risk analysis report further comprises assigning said score a loan performance scalability impact weight.

In another embodiment, the method further comprises highlighting key risk sections of said risk related template wherein said highlighting indicates at least one of missing input data; missing analysis data; incorrect information; valid data type in said field; and invalid data type in said field.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A computer-implemented method for due diligence reporting, the method comprising:
gathering data relevant to a loan from data sources;
populating a risk related template, by a computer, according to the gathered data;
gathering verified data;
comparing, by said computer, the gathered data with the verified data;
identifying variances between the gathered data and the verified data; and
generating a risk analysis report, by said computer, according to the identified variances.

2. The method of claim 1 wherein said risk analysis report comprises a score for at least one of:
an individual loan summary scorecard;
an underwriter scorecard; and
an underwriter credit risk score.

3. The method of claim 2 wherein comparing, by said computer, the gathered data with the verified data further comprises:
validating said gathered data; and
determining delta variances between said gathered data and said verified data.

4. The method of claim wherein said verified data comprises data provided by a third party.

5. The method of claim 2 wherein generating said risk analysis report further comprises assigning said score a loan performance scalability impact weight.

6. The method of claim 1 further comprising manually reviewing said gathered data relevant to said loan and said gathered verified data.

7. The method of claim 1 further comprising highlighting key risk sections of said risk related template.

8. A method of claim 7 wherein said highlighting indicates at least one of:
missing input data;
missing analysis data;
incorrect information;
valid data type in said field; and
invalid data type in said field.

9. A system for due diligence reporting comprising:
a processor; and
a computer-usable medium embodying computer code, said computer-usable medium being coupled to said processor, said computer code comprising non-transitory instruction media executable by said processor for:
gathering data relevant to a loan from data sources;
populating a risk related template according to the gathered data;
gathering verified data;
comparing the gathered data with the verified data;
identifying variances between the gathered data and the verified data; and
generating a risk analysis report according to the identified variances.

10. The system of claim 9 wherein said risk analysis report comprises a score for at least one of:
an individual loan summary scorecard;
an underwriter scorecard; and
an underwriter credit risk score.

11. The system of claim 10 wherein comparing the gathered data with the verified data further comprises:
validating said gathered data; and
determining delta variances between said gathered data and said verified data.

12. The system of claim 9 wherein said verified data comprises data provided by a third party.

13. The system of claim 10 wherein generating said risk analysis report further comprises assigning said score a loan performance scalability impact weight.

14. The system of claim 9 further comprising manually reviewing said gathered data relevant to said loan and said gathered verified data.

15. The system of claim 9 further comprising highlighting key risk sections of said risk related template.

16. A method of claim 15 wherein said highlighting indicates at least one of:
missing input data;
missing analysis data;
incorrect information;
valid data type in said field; and
invalid data type in said field.

17. A computer-implemented method for due diligence reporting, the method comprising:
gathering data relevant to a loan from data sources;
populating a risk related template, by a computer, according to the gathered data;
gathering verified data;
validating said gathered data;
determining delta variances between said gathered data and said verified data;
comparing, by said computer, the gathered data with the verified data;
identifying variances between the gathered data and the verified data;
manually reviewing said gathered data relevant to said loan and said gathered verified data; and
generating a risk analysis report, by said computer, according to the identified variances.

18. The method of claim 17 wherein said risk analysis report comprises a score for at least one of:
an individual loan summary scorecard;
an underwriter scorecard; and
an underwriter credit risk score.

19. The method of claim 18 wherein generating said risk analysis report further comprises assigning said score a loan performance scalability impact weight.

20. The method of claim 19 further comprising highlighting key risk sections of said risk related template wherein said highlighting indicates at least one of:
missing input data;
missing analysis data;
incorrect information;
valid data type in said field; and
invalid data type in said field.
